(19) United States
(12) Patent Application Publication
(10) Pub. No.: US 2011/0139593 A1
(43) Pub. Date: Jun. 16, 2011

(54) ELECTRICAL SWITCH WITH PIVOTING SWITCHING MEMBER AND IMPROVED SUPPORTING FULCRUM AND METHOD FOR MANUFACTURING SAID SWITCH

(75) Inventor: Fabio Bertagna, Varese (IT)

(73) Assignee: BTICINO S.p.A., Milano (IT)

(21) Appl. No.: 13/054,765

(22) PCT Filed: Jun. 26, 2009
(86) PCT No.: PCT/EP2009/058022

§ 371 Date: Mar. 3, 2011

(30) Foreign Application Priority Data
Jul. 31, 2008 (IT) RM2008A000417

(51) Int. Cl. H01H 1/22; H01H 11/00

(52) U.S. Cl. 200/244; 29/622

(57) ABSTRACT

The invention describes an electrical switch comprising: at least two connection terminals (T1, T2),—a fixed electrical contact (3) electrically connected to one (T2) of the two connection terminals (T1, T2),—a pivoting and electrically conductive switching member (2), comprising at least one mobile electrical contact (4), suitable for oscillating between two preset positions, in one of which the mobile electrical contact (4) is in abutment against the fixed electrical contact (3),—a supporting fulcrum (1) for the pivoting switching member (2), the supporting fulcrum (1) being electrically conductive and electrically connected to the other of the two connection terminals (T1). The supporting fulcrum (1) further includes mechanical coupling means (5) suitable for constraining the pivoting switching member (2) to the supporting fulcrum (1).

The present invention refers to electrical switches and, more specifically, to switches of the type in which the switching takes place through the displacement between two stable positions of a pivoting switching member. In greater detail, the present invention refers to an electrical switch with a pivoting switching member and an improved supporting fulcrum and to a method for manufacturing such a switch.

In the present description, by the term electrical switch we mean to designate both a device for opening and closing a single contact and a device for opening one contact whilst simultaneously closing another contact and vice-versa (diverter).

In the state of the art there are various types of switches of the kind indicated above, generally including: at least two connection terminals, at least one fixed electrical contact electrically connected to one of the two connection terminals and a switching member, equipped at one end with at least one mobile electrical contact and bearing on a supporting fulcrum electrically connected to the other of the two connection terminals. Such switches also include an actuation mechanism that can be manoeuvred through an axial button, or a lever, or a flip switch to move the switching member so that, by rotating, it reaches one or the other of its two stable positions.

An example of a switch of the type indicated above and with button actuation is described in international patent application WO 2006/106554.

Through experiments carried out using a high-speed video camera it has been possible to observe that in switches of the prior art described above, the pivoting switching member, during switching, can lift up from the supporting fulcrum although it is for example held against it by suitable elastic means.

Such detachment, even if limited to a few fractions of a second, can jeopardise the correct operation of the switch. Indeed, during such detachment micro electric arcs form that cause localised corrosion or melting that can in turn cause overheating or interruptions in the flow of current.

The Applicant has already found a solution to such a problem by foreseeing, as described in the European patent application published as EP 1 930 927, an elastically deformable conductive element arranged between the supporting fulcrum and the pivoting switching member in order to preserve the electrical continuity between such a member and the fulcrum. The solution described in the aforementioned European patent application EP 1 930 927, whilst being particularly effective in avoiding the problem of bounces, is currently relatively expensive because it introduces a complication in the production method. In practice, such a complication is essentially caused by the correct positioning of the elastically deformable conductive element between the fulcrum and the pivoting switching member.

The purpose of the present invention is to provide an electrical switch that provides an alternative solution to the problem of bounces with respect to the one already described in the aforementioned European patent application EP 1 930 927 and that can be made through a relatively less complex and costly production method.

Such a purpose is accomplished through a switch as defined in general in claim 1. Preferred and advantageous embodiments of a switch in accordance with the present invention are defined in the attached dependent claims.

The object of the present invention is also a method for manufacturing a switch, as defined in general in the attached claim 11.

The invention will be better understood from the following detailed description of particular embodiments given as examples and, therefore, in no way limiting, in reference to the attached figures, in which:

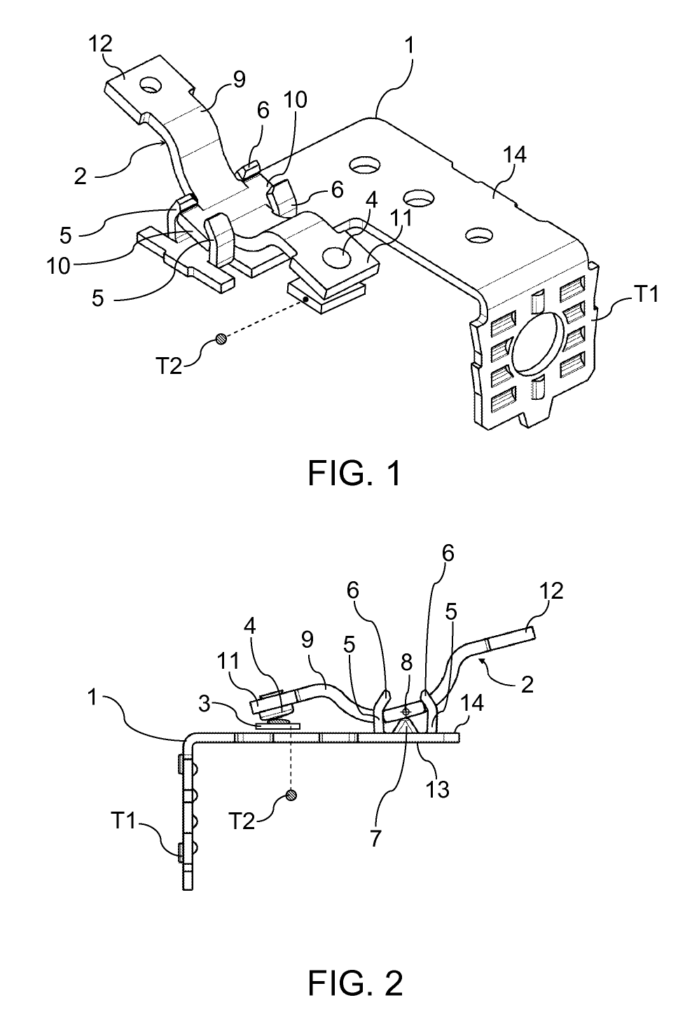

FIG. 1 shows a perspective view of a fulcrum-rocker arm group of a switch in accordance with a currently preferred embodiment of the present invention;

FIG. 2 shows a side view of the fulcrum-rocker arm group of FIG. 1;

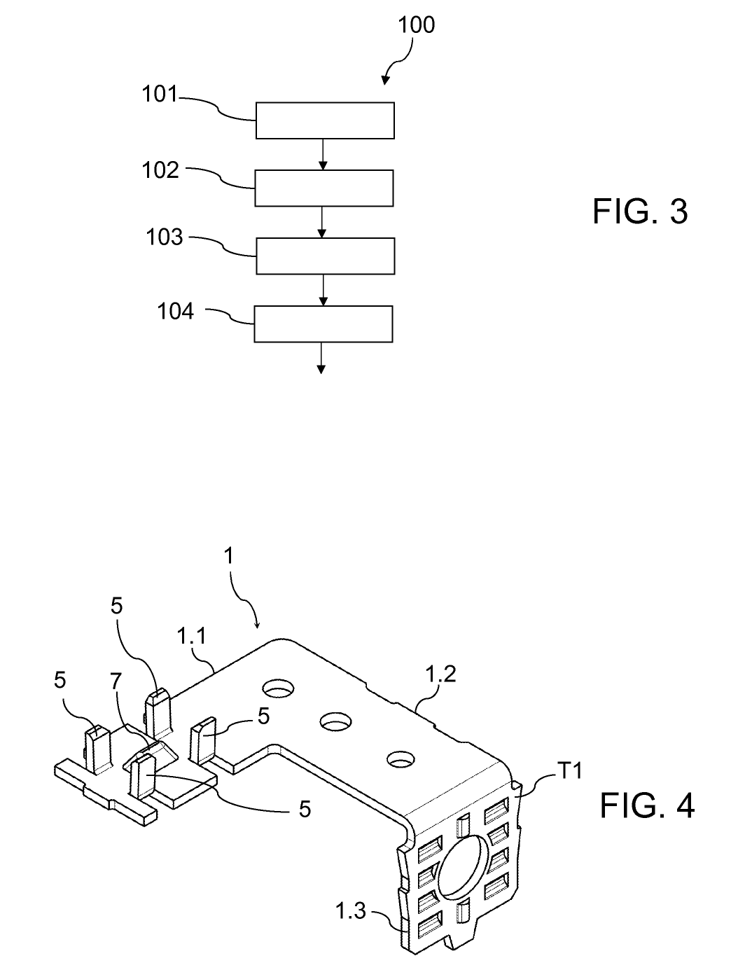

FIG. 3 shows a flow diagram with some steps of a manufacturing method in accordance with the present invention;

FIG. 4 shows a perspective view of a semi-machined fulcrum obtained in output from a step of the method of FIG. 3; and

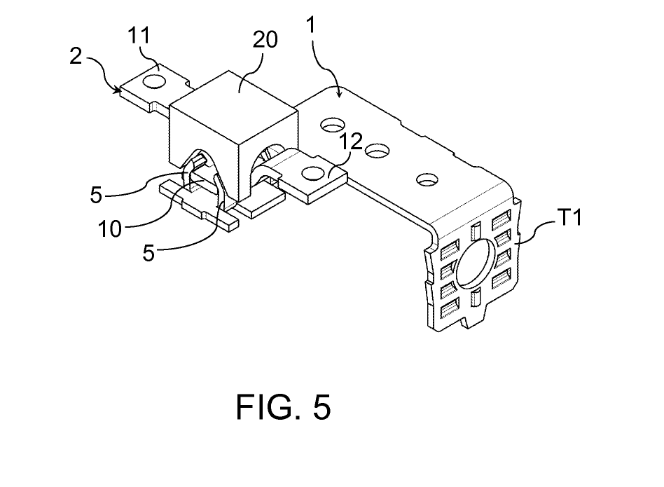

FIG. 5 shows a perspective view that illustrates a mechanical machining operation of the supporting fulcrum of FIG. 4.

In the figures, identical or similar elements shall be indicated with the same reference numerals.

With reference to the attached figures a particularly preferred embodiment of an electrical switch in accordance with the present invention will be described hereafter.

As already stated, in the present description, by the term switch we mean to indicate both a device for opening and closing a single contact and a device for opening one contact whilst simultaneously closing another contact and vice-versa (diverter).

The electrical switch, a group of parts comprising a pivoting switching member 2 and a supporting fulcrum 1 (or fulcrum-rocker arm group) of which is essentially represented in the figures, comprises a first T1 and a second T2 electrical connection terminal. Preferably, such terminals T1, T2 are of the type with a screw clamp. In the figures, the terminal T2 has only been represented schematically. The supporting fulcrum 1 is made from electrically conductive material, for example brass.

The switch comprises a pivoting switching member 2 suitable for establishing electrical connections, which in the particular example represented is in the form of a pivoting bridge 2, in practice a rocker arm, made from electrically conductive material, for example brass. Henceforth in the present description we shall refer to the pivoting switching member 2 also using the expression “pivoting bridge 2” or “rocker arm 2”, without for this reason introducing any limitation.

In the example, the rocker arm 2 comprises a rod 9 pivoting around the rotation axis 8 (in FIG. 2 the axis 8 is perpendicular to the plane of the sheet) and having the shape of an inverted saddle with a central part with rounded profile. In other words, the pivoting rod 9 has a longitudinal section having the shape of an inverted hat. The central part of the pivoting rod 9 bears on the supporting fulcrum 1 and is in electrical contact with the latter. The pivoting rod 9 comprises two end portions 11, 12 at least one 11 of which carries a mobile electrical contact 4. In a variant embodiment the end portion 12 of the pivoting rod 9 is also equipped with a mobile electrical contact.

The rocker arm 2 is such as to be able to be moved to rotate around its central supporting part in order to establish electrical connections between the terminal T1 and the terminal T2. In particular, the rocker arm 2 is suitable for oscillating between two preset positions, in one of which the mobile electrical contact 4 is in abutment against the fixed electrical contact 3.

The electrical switch also includes a control mechanism, not visible in the figures, suitable for moving the rocker arm 2. In a particularly preferred, but not limiting, embodiment, the control mechanism is made in accordance with the teachings of international patent application WO 2006/106554, in which the movement of the rocker arm 2 is obtained by running a pivoting and sprung pin (not represented in the figures of the present patent application) on it. Although the aforementioned international patent application refers to an axial button switch, it should be kept in mind that the teachings of the present invention are also applicable in a totally similar way to a switch with a flip switch or with a lever.

Advantageously, the supporting fulcrum 1 comprises mechanical coupling means or elements 5 suitable for constraining the rocker arm 2 to the supporting fulcrum 1. In a particularly advantageous embodiment such mechanical coupling means or elements comprise a hinge 5.

Preferably, the mechanical coupling means 5 are integrated with the supporting fulcrum 1 and more preferably the supporting fulcrum 1 comprises a main body made from metal sheet that is cut and bent and the mechanical coupling means 5 are obtained by cutting and bending parts of said sheet. With reference to the fulcrum represented in the attached figures, it should be observed that in practice the supporting fulcrum comprises a metal sheet comprising a supporting portion on which the switching member bears and a coupling portion that is bent with respect to said supporting portion comprising mechanical coupling means or elements 5 suitable for constraining the pivoting switching member 2 to the supporting fulcrum 1. In the example represented, the supporting portion is in the form of an essentially plate-shaped portion of sheet lying in a plane parallel to the rotation axis of the switching member.

In the currently preferred embodiment represented in the figures, the mechanical coupling means comprise a first and a second pair of arms 5 arranged on opposite sides with respect to the rocker arm 2. In such an embodiment the arms 5 are arranged at the vertexes of a quadrilateral. As represented in FIG. 2, the supporting fulcrum 1 preferably comprises a supporting wedge 7 for the rocker arm 2, arranged on the supporting fulcrum 1 substantially at the centre of the quadrilateral formed by the arms 5. Preferably, but not for limiting purposes, such a supporting wedge 7 is an element made from material with high conductivity, like for example a silver pellet, fixed to the supporting fulcrum 1 by soldering. In an alternative embodiment, the supporting wedge 7 is integrated with the supporting fulcrum 1 and is obtained through a punching operation of the supporting fulcrum 1 performed in the opposite side of the face 13 thereof with respect to the face 14 from which such a supporting wedge 7 projects.

In a particularly advantageous embodiment, the rocker arm 2 comprises two lateral wings 10 connected to the pivoting rod 9, which project from the central portion of the rod 9 perpendicularly to such a rod 9 and from opposite sides with respect to the latter. In such an embodiment the mechanical coupling means 5 are such as to cooperate with the lateral wings 10 to constrain the rocker arm 2 to the supporting fulcrum 1.

Advantageously, it is possible to foresee that, as represented in the figures, the arms 5 be equipped with a free end portion 6 that is bent so that each pair of arms 5 is such as to hold a respective lateral wing 10 coupled with the supporting fulcrum 1 defining a hinged constraint. Preferably, the bending of such end portions 6 is obtained after having positioned the rocker arm 2 on the supporting fulcrum more preferably using a forming die 20 that for the bending acts as a lever on the wings themselves (which in practice act as a punch). Advantageously, after the bending performed as described above, the elastic return of the material allows a reduced clearance to be created between the arms 5 and the wings 10, for example of the order of a hundredth of a mm, which allows the rocker arm 2 to be constrained to the supporting fulcrum 1 and at the same time be free to rotate around the axis 8. Preferably, as represented in the figures, the end portion 6 of the arms 5 as well as being bent is also bevelled, to make it easier to position the rocker arm 2 on the supporting fulcrum 1.

With reference to FIGS. 3, 4 and 5 a currently preferred embodiment of a method 100 for manufacturing an electrical switch comprising a fulcrum-rocker arm group of the type described above will now be described. In the description of the method we shall limit ourselves to describing the manufacturing steps of the fulcrum-rocker arm group.

The method 100 comprises:
a step 101 of cutting and bending a metal sheet to obtain a supporting fulcrum 1;
a step 103 of positioning a switching member 2 on the supporting fulcrum 1; and
a further step 104 of mechanically machining the supporting fulcrum 1 making coupling means or elements 5 modifying the shape of said fulcrum after said positioning step to mechanically couple the switching member 2, or rocker arm 2, with the supporting fulcrum 1.

Preferably, the metal sheet is made from brass. Preferably, the supporting fulcrum 1 provided at the end of step 101 is formed from two perpendicular branches 1.1, 1.2, one of which 1.2 is bent to obtain a wall of connection terminal T1 perpendicular to the plane of the sheet.

In a particularly advantageous embodiment:
the step of cutting and bending 101 the sheet comprises an operation of forming constraint means 5, like for example four straight rods 5 in FIG. 4, for the positioning of the rocker arm 2 with respect to the supporting fulcrum 1, and preferably this step also comprises an operation of bevelling the free ends 6 of the straight rods 5; and
the step 104 of mechanically machining the supporting fulcrum 1 to mechanically couple the rocker arm 2 with the supporting fulcrum 1 comprises an operation of modifying the shape of said constraint means to mechanically couple the rocker arm 2 with the supporting fulcrum 1.

With reference to FIG. 5 the operation of modifying the shape of the constraint means 5 comprises a bending operation in which a forming die 20 is used (FIG. 5) suitable for bending an end portion 6 of the rods 5 in order to make the arms 5. Advantageously, it is possible to foresee that the switching member 2 be provided with lateral wings 10 that during such a bending operation act in practice as a punch guiding the bending of the rods 5.

In an advantageous preferred and not limiting embodiment it is possible to foresee that the positioning step 103 of the switching member 2 on the supporting fulcrum 1 be performed through the same forming die 20. In practice it is possible to advantageously foresee that the forming die 20 act as gripping element suitable for picking up, transporting and positioning the rocker arm 2 on the supporting fulcrum 1 and that the bending of the rods 5 be performed at the same time as the positioning of the rocker arm 2. For example, the coupling between forming die and rocker arm 2 to grip hold of such a rocker arm and position it on the fulcrum 1 can be of the interlocking type.

As an alternative to the embodiment described above, it is possible to foresee that the positioning step of the rocker arm 2 be performed through a distinct tool from the forming die 20, for example through a pincer, before the mechanical machining step 104.

Preferably, the method 100 also comprises, before performing the positioning step 103, a step 102 of making a supporting wedge 7 on the supporting fulcrum 1. Preferably, this step 101 comprises an operation of soldering a wedge element 7 made from conductive material, preferably silver, to the supporting fulcrum 1. Alternatively, step 100 could comprise an operation of punching the sheet of the supporting fulcrum 1 on one side 13 to create a substantially wedge shaped ridge on the other side 14 of the sheet.

From the description that has just been made it is possible to understand how a switch and a method in accordance with the invention fully achieve the preset purposes, since the mechanical coupling means between the supporting fulcrum 1 and the rocker arm 2 eliminate or drastically reduce the problem of bounces and the method for manufacturing the fulcrum-rocker arm group is relatively cost-effective.

Tests have also demonstrated the efficiency of the proposed new solution. Indeed, through tests foreseen by current regulations for switches in accordance with the present invention it has been seen that there is a significant reduction, by about 10° C., compared to the typical performance of switches of the prior art (those that do not have the continuity spring described in the aforementioned European patent application EP 1 930 927), in the temperature at the terminals of the switches. This is clearly indicative of the drastic reduction in the bounce phenomenon.

Moreover, visual inspections have demonstrated that, whereas after a test with 40,000 manoeuvres according to the current regulations for switches of the state of the art (those that do not have the continuity spring described in the aforementioned European patent application EP 1 930 927) they have clear traces or erosion and burning on the fulcrum and on the switching member, in the switches in accordance with the present invention there are no clear traces of erosion and burning or else such traces are significantly reduced.

Of course, a man skilled in the art can bring numerous modifications and variants to the switch and to the method described above, in order to satisfy contingent and specific requirements, all of which are covered by the scope of protection of the invention, as defined by the following claims.

1. Electrical switch comprising:
at least two connection terminals,
a fixed electrical contact electrically connected to one of the two connection terminals,
a pivoting and electrically conductive switching member, comprising at least one mobile electrical contact, suitable for oscillating between two preset positions, in one of which the mobile electrical contact is in abutment against the fixed electrical contact,
a supporting fulcrum for the pivoting switching member, the supporting fulcrum being electrically conductive and electrically connected to the other of the two connection terminals,
wherein the supporting fulcrum comprises a metal sheet comprising a supporting portion on which the switching member rests and a coupling portion bent with respect to said supporting portion comprising mechanical coupling means suitable for constraining the pivoting switching member to the supporting fulcrum.

2. The switch according to claim 1, wherein the mechanical coupling means comprise a hinge.

3. The switch according to claim 1, wherein the mechanical coupling means are integrally realized with said supporting fulcrum.

4. The switch according to claim 3, wherein the mechanical coupling means are obtained by cutting and bending portions of said sheet.

5. The switch according to claim 1, wherein the mechanical coupling means comprise a first and a second pair of arms bent back with respect to said supporting portion, said pairs of arms being arranged on opposite sides with respect to the switching member.

6. The switch according to claim 5, wherein the arms are arranged at the vertexes of a quadrilateral and the fulcrum comprises a supporting wedge for the switching member, the wedge being arranged on the supporting fulcrum substantially at the centre of said quadrilateral.

7. The switch according to claim 6, wherein the supporting wedge is a pellet fixed by soldering to the remaining part of said fulcrum.

8. The switch according to claim 1, wherein the switching member comprises:
a rod pivoting like a rocker arm and having a central portion bearing on the supporting fulcrum, and
two lateral wings connected to the pivoting rod, projecting from said central portion perpendicularly to such a rod and from opposite sides with respect to the latter;
wherein the mechanical coupling means are such as to cooperate with the lateral wings to constrain the switching member to the fulcrum.

9. The switch according to claims 6, wherein the arms have a free end portion bent inwards so that each pair of arms is such as to hold a respective lateral wing constrained to the supporting fulcrum.

9. The switch according to claims 6, wherein the arms have a free end portion bent inwards so that each pair of arms is such as to hold a respective lateral wing constrained to the supporting fulcrum.

10. The switch according to claim 9, wherein the free end portion is bent through a bending operation performed after having positioned the switching member on the supporting fulcrum.

11. Method for manufacturing an electrical switch, sequentially comprising the steps of:
cutting and bending a metal sheet to make a supporting fulcrum;
positioning a pivoting switching member on the supporting fulcrum that has been cut and bent; and
mechanically machining the supporting fulcrum making coupling elements by modifying the shape of said fulcrum after said positioning step, to mechanically couple the pivoting switching member with the supporting fulcrum.

12. The method according to claim 11, wherein said further step of modifying the shape is such as to create a hinged constraint between the pivoting switching member and the supporting fulcrum.

13. The method according to claim 11, wherein the step of cutting and bending the sheet includes an operation of forming constraint means for positioning the pivoting switching member with respect to the supporting fulcrum and wherein said further step of modifying the shape is such as to modify the shape of said constraint means to mechanically couple the pivoting switching member with the supporting fulcrum.

14. The method according to claim 11, wherein said further step of modifying the shape is performed using a forming die.

15. The method according to claim 14, wherein the step of positioning the pivoting switching member on the supporting fulcrum comprises the steps of:
coupling the switching member with the forming die;
positioning the switching member on the fulcrum through the forming die;
wherein said further step is performed at the same time as said positioning operation.

16. The switch according to claim 8, wherein the arms have a free end portion bent inwards so that each pair of arms is such as to hold a respective lateral wing constrained to the supporting fulcrum.

17. The switch according to claim 16, wherein the free end portion is bent through a bending operation performed after having positioned the switching member on the supporting fulcrum.
